(19) United States
(12) Patent Application Publication
(10) Pub. No.: US 2026/0119776 A1
(43) Pub. Date: Apr. 30, 2026

(54) METHOD FOR PREDICTION OF PROCESS DEFECTS

(71) Applicant: SAMSUNG ELECTRONICS CO., LTD., Suwon-si (KR)

(72) Inventors: Min-Chul Park, Suwon-si (KR); Segab Kwon, Suwon-si (KR); Sangyeon Kim, Suwon-si (KR); Yeji Kim, Suwon-si (KR); Seongryeol Kim, Suwon-si (KR); Young-Gu Kim, Suwon-si (KR)

(21) Appl. No.: 19/177,311

(22) Filed: Apr. 11, 2025

(30) Foreign Application Priority Data
Oct. 30, 2024 (KR) 10-2024-0151101

(51) Int. Cl. G06F 30/398; G06T 7/00; G06T 7/50

(52) U.S. Cl. CPC G06F 30/398; G06T 7/0006; G06T 7/0008; G06T 7/50; G06T 2207/10024; G06T 2207/20021; G06T 2207/20081; G06T 2207/30148

(57) ABSTRACT

The present disclosure relates to a method for prediction of process defects performed by at least one processor, the method including receiving design data including a plurality of layout patterns corresponding to a plurality of layers of a semiconductor chip, dividing the design data into tile regions, and generating a plurality of height maps corresponding to a plurality of tile regions, and determining a presence of process defects associated with the plurality of tile regions based on the plurality of height maps.

### CROSS-REFERENCE TO RELATED APPLICATION

The present application claims priority to Korean Patent Application No. 10-2024-0151101, filed on Oct. 30, 2024, the entire contents of which are incorporated herein for all purposes by this reference.

### BACKGROUND

With the advancement of the semiconductor device manufacturing process, defects frequently occur due to height differences between patterns formed during a manufacturing process. Particularly, in many cases, height differences between patterns that occur during a specific process step are transferred to a subsequent process to cause defects, and it is difficult to identify the fundamental causes of defects only through measurement monitoring.

Defects caused by height differences between patterns that occur during the manufacturing process of semiconductors may directly affect yields, and the yield is a key factor in determining product quality and manufacturing costs. Therefore, it is essential to detect defects generated due to height differences between patterns with great speed and effectively analyze the causes to ensure high yields and stable manufacturing process.

### SUMMARY

The present disclosure aims to provide a method of determining a specific region in design data to be predicted to cause defects in the manufacturing process of semiconductor devices.

The problem to be solved is not limited the above, but the other tasks not mentioned above may be explicitly known to those skilled in the art from the description of the present disclosure below.

According to implementations of the present disclosure, there is provided a method for prediction of process defects performed by at least one processor, the method including receiving design data including a plurality of layout patterns corresponding to a plurality of layers of a semiconductor chip, dividing the design data into tile regions, and generating a plurality of height maps corresponding to a plurality of tile regions, and determining a presence of process defects associated with the plurality of tile regions based on the plurality of height maps.

According to implementations of the present disclosure, there is provided a method for prediction of process defects performed by at least one processor, the method including receiving design data including a plurality of layout patterns corresponding to a plurality of layers of a semiconductor chip, dividing the design data into tile regions, and generating a plurality of height maps corresponding to a plurality of tile regions, generating a plurality of 3D representations respectively corresponding to the plurality of height maps, and determining a presence of process defects associated with the plurality of tile regions based on the plurality of 3D representations.

According to implementations of the present disclosure, there is provided a method for prediction of process defects performed by at least one processor, the method including receiving design data including a plurality of layout patterns corresponding to a plurality of layers of a semiconductor chip, dividing the design data into a plurality of tile regions, generating a plurality of height maps respectively corresponding to the plurality of tile regions by predicting a height value of each point in each tile region, generating a plurality of high-resolution height maps based on each of the plurality of height maps, generating a plurality of 3D representations based on the plurality of high-resolution height maps, performing a process simulation based on surface shapes of respective tile regions corresponding to the plurality 3D representations, and determining a defect region outside of a predetermined threshold range based on changed surface shapes of the respective tile regions according to a result of the process simulation.

According to one or more exemplary implementations, instead of directly measuring semiconductor devices manufactured based on design data, defects that may occur due to height differences between patterns formed during a process may be predicted by using layout patterns within design data. Therefore, process defects that may potentially occur according to the layout patterns may be detected with great speed.

According to one or more exemplary implementations, defects may be identified through subsequent process simulations flexibly adjusted based on layout patterns and process defects may be analyzed from various perspectives by selecting various application processes to identify process defects in advance and effectively responding thereto.

According to one or more exemplary implementations, prediction of defects for full-chip design data may be performed with great speed by dividing design data into a plurality of tile regions and performing an individual simulation based on height information of each tile region.

The effect that is obtained from the present disclosure is not limited to the above. The technical effect not mentioned above may be explicitly known to those skilled in the art from the description below.

### BRIEF DESCRIPTION OF DRAWINGS

FIG. 1 is a block diagram provided to explain an example of a process defect prediction device according to one or more exemplary implementations of the present disclosure;

FIG. 2 is a block diagram provided to explain an example of a method of prediction of process defects by using design data according to an implementation of the present disclosure;

FIG. 3 is a block diagram provided to explain an example of a method of prediction of process defects by using design data according to another implementation of the present disclosure;

FIG. 4 is a block diagram provided to explain an example of a method of prediction of process defects by using design data according to yet another implementation of the present disclosure;

FIG. 5 is a block diagram provided to explain an example of a method of prediction of process defects by using design data according to yet another implementation;

FIG. 6 is a diagram provided to explain a method of generating height maps according to one or more exemplary implementations of the present disclosure;

FIG. 7 is a diagram provided to explain a method of generating height maps according to one or more exemplary implementations of the present disclosure;

FIG. 8 is a diagram provided to explain a method of generating high-resolution height maps according to one or more exemplary implementations of the present disclosure;

FIG. 9 is a diagram provided to explain a method of high-resolution generating height maps according to one or more exemplary implementations of the present disclosure;

FIG. 10 is a diagram provided to explain a method of generating high-resolution height maps according to one or more exemplary implementations of the present disclosure;

FIG. 11 is a diagram provided to explain a method of generating 3D representations according to one or more exemplary implementations of the present disclosure;

FIG. 12 is a diagram provided to explain a method of determining defect regions according to one or more exemplary implementations of the present disclosure;

FIG. 13 is an exemplary diagram illustrating a method of determining defect regions through a performance result of a process simulation for each tile region according to one or more exemplary implementations of the present disclosure;

FIG. 14 is an exemplary diagram illustrating a process defect color map including defect regions determined according to one or more exemplary implementations of the present disclosure;

FIG. 15 is a flowchart illustrating an example of a method of prediction of process defects according to one or more exemplary implementations of the present disclosure;

FIG. 16 is a flowchart illustrating an example of a method of prediction of process defects according to one or more exemplary implementations of the present disclosure;

FIG. 17 is a flowchart illustrating an example of a method of prediction of process defects according to one or more exemplary implementations of the present disclosure; and

FIG. 18 is a block diagram illustrating an example of a process defect prediction system according to one or more exemplary implementations of the present disclosure.

### DETAILED DESCRIPTION

The present disclosure relates to a method for prediction of process defects, and more particularly, to a method for determining a specific region in design data predicted to cause defects in a manufacturing process of semiconductor devices.

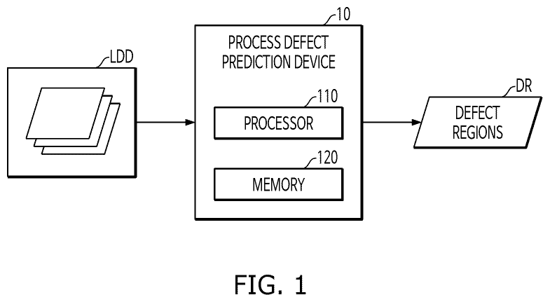

With reference to FIG. 1 to FIG. 18, various exemplary implementations of the present disclosure will be described. Like reference numerals in the drawings denote like elements throughout the specification.

FIG. 1 is a block diagram provided to explain an example of a process defect prediction device 10 according to one or more exemplary implementations of the present disclosure.

Referring to FIG. 1, a process defect prediction device 10 may determine defect regions DR predicted to have defects caused by height differences between layout patterns in layout design data LDD based on the layout design data LDD. The layout design data LDD may include a plurality of layout patterns corresponding to a plurality of layers in a semiconductor chip. The layout patterns may include information on the shape, arrangement, size, and thickness of the pattern required for each layer formation phase of the semiconductor chip. The vertical alignment of the plurality of layout patterns may lead to height differences between the patterns included in each region of the layout design data LDD.

According to one or more exemplary implementations, the layout design data LDD may include layout patterns up to predetermined process stages of the entire manufacturing process of the semiconductor chip. The layout patterns up to the predetermined process stages may be layout patterns that effectively predict defects due to the height differences between the layout patterns in the defect region DR among the entire layout patterns of the semiconductor device. For example, the layout patterns to the predetermined process stages may be selected by using a machine learning model, but the present disclosure is not limited thereto.

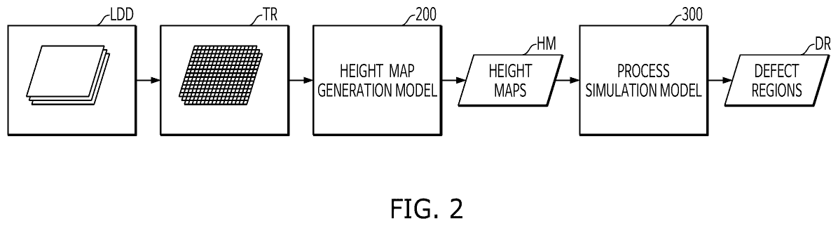

According to one or more exemplary implementations, the process defect prediction device 10 may determine the presence of process defects related to a plurality of tile regions based on a plurality of height maps corresponding to a plurality of tile regions in the layout design data LDD. The method for determining the defect regions DR will be described in detail with reference to FIG. 2 to FIG. 17. Additional research or analysis to resolve the causes for defects may be performed by the process defect prediction device 10 and/or an external device on the tile regions determined to have the process defects among the plurality of tile regions.

According to one or more exemplary implementations, a suspected layout pattern predicted to cause process defects among the plurality of layout patterns may be identified based on the tile region determined to have process defects among the plurality of tile regions through the process defect prediction device 10 and/or the external device. A subsequent procedure may be performed on the identified suspected layout pattern, for example, modifications to the layout patterns.

The process defect prediction device 10 may include a processor 110 and a memory 120. For example, the process defect prediction device 10 may be a computing system such as a personal computer, a mobile phone, a server, etc., a module in which a plurality of processing cores and memories are mounted on a substrate as independent packages, or a system-on-chip (SoC) in which a plurality of processing cores and memories are embedded in a single chip.

The processor 110 may communicate with the memory 120 and execute instructions. According to one or more exemplary implementations, the processor 110 may execute a program stored in the memory 120. The program may include a series of instructions. The processor 110 may be any hardware capable of independently executing instructions and may be referred to as, for example, an Application Processor (AP), a Communication Processor (CP), a Central Processing Unit (CPU), a Graphics Processing Unit (GPU), a processor core, a core, etc.

The processor 110 may communicate with the memory 120. The memory 120 may be accessed by the processor 110 and may store software elements executable by the processor 110. The software elements may include, software components, programs, applications, computer programs, application programs, system programs, software development programs, machine programs, operating system (OS) software, middleware, firmware, software modules, routines, subroutines, functions, methods, procedures, software interfaces, application program interfaces (APIs), instruction sets, computing codes, computer codes, code segments, computer code segments, words, values, symbols, or combinations of two or more thereof, but the present disclosure is not limited thereto.

The memory 120 may be any hardware capable of storing information and accessible by the processor 110. For example, the memory 120 may include a read only memory (ROM), a random-access memory (RAM), a dynamic random access memory (DRAM), a double-data-rate dynamic random access memory (DDR-DRAM), a synchronous dynamic random access memory (SDRAM), a static random access memory (SRAM), a magnetoresistive random access memory (MRAM), a programmable read only memory (PROM), an erasable programmable read only memory (EPROM), an electrically erasable programmable read only memory (EEPROM), a flash memory, a polymer memory, a phase change memory, a ferroelectric memory, a silicon-oxide-nitride-oxide-silicon SONOS memory, a magnetic card/disk, an optical card/disk, or a combination of two or more thereof.

Instructions for performing a process defect prediction method according to one or more exemplary implementations of the present disclosure may be stored in a computer-readable non-transitory storage medium. The term “computer-readable medium” may include any type of medium accessible by computers, such as a read only memory (ROM), a random access memory (RAM), a hard disk drive, a compact disc CD, a digital video disc DVD, or any other type of memory. The “non-transitory” computer-readable medium may exclude wired, wireless, optical, or other communication links that transmit transitory electricity or other signals and include a medium on which data is permanently stored and a medium on which data is stored and overwritten such as a rewritable optical disk or an erasable memory device.

FIG. 2 is a block diagram provided to explain an example of a method for prediction of process defects by using the layout design data LDD according to one or more exemplary implementations.

Referring to FIG. 2, a process defect prediction device (or a processor) may receive the layout design data LDD including a plurality of layout patterns corresponding to a plurality of layers in a semiconductor chip, and divide the received layout design data LDD into a plurality of tile regions TR. According to one or more exemplary implementations, the process defect prediction device may divide the layout design data LDD into a plurality of tile regions TR by using a window of a predetermined size. For example, each of the plurality of tile regions TR may have a size of 5 μm×5 μm, but the present disclosure is not limited thereto.

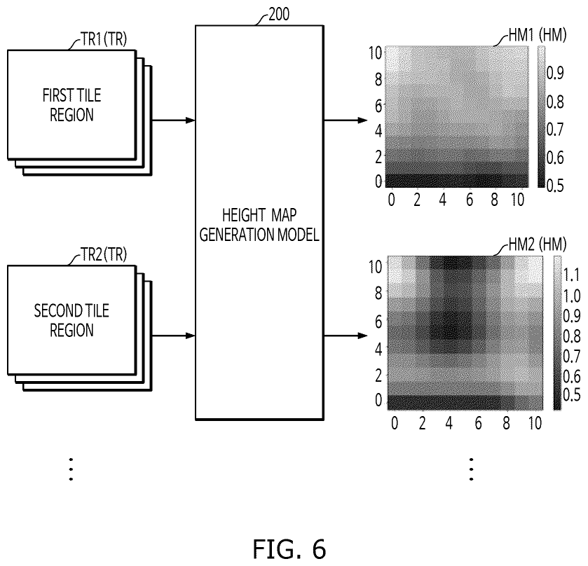

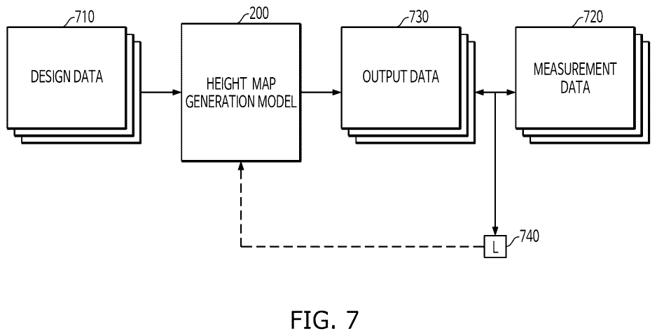

The process defect prediction device may generate a plurality of height maps HM corresponding to the plurality of tile regions. For example, the process defect prediction device may generate the plurality of height maps HM including height maps respectively corresponding to the plurality of tile regions by using a height map generation model 200. A specific example of the method for generating the plurality of height maps HM will be described in detail with reference to FIG. 6 and FIG. 7.

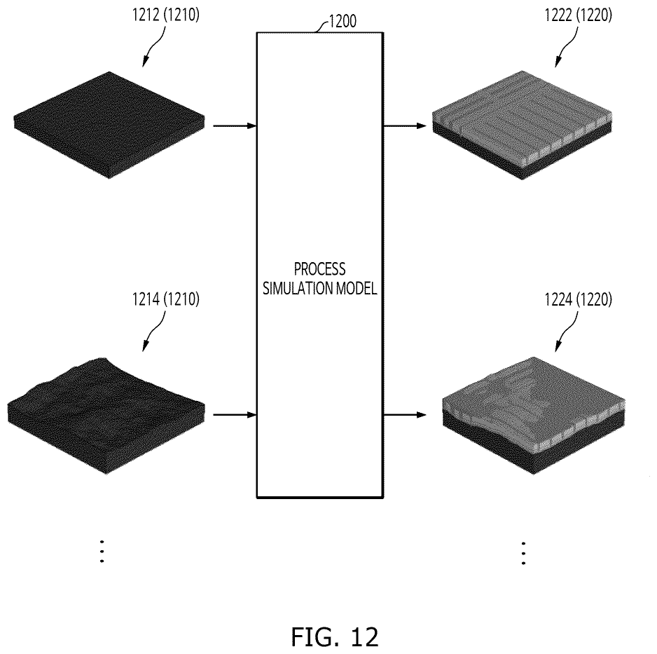

The process defect prediction device may determine the presence of process defects associated with the plurality of tile regions TR based on the plurality of height maps HM. For example, the process defect prediction device may perform a process simulation based on the surface shape of each of the plurality of tile regions TR corresponding to the plurality of height maps HM. The process defect prediction device may determine the defect region DR outside of a predetermined threshold range based on the changed surface shape of each of the plurality of tile regions TR according to the result of the process simulation. A specific example of the method for determining the defect region DR by using the process simulation model 300 will be described in detail with reference to FIG. 12 to FIG. 14.

According to one or more exemplary implementations, defects that may occur due to the height differences between patterns formed during the process may be predicted by using the layout patterns in the layout design data LDD rather than directly measuring the semiconductor device manufactured based on the layout design data LDD, thereby detecting the process defects that may occur according to the layout patterns with great speed.

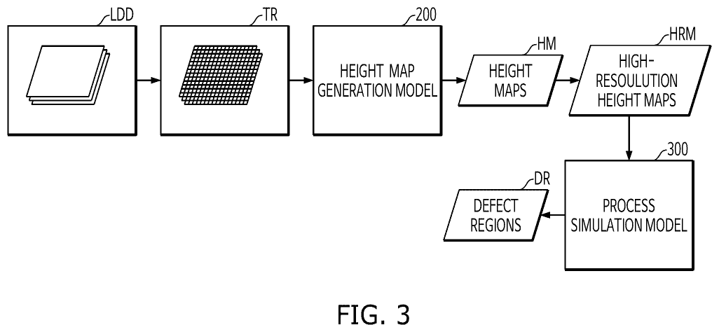

FIG. 3 is a block diagram provided to explain an example of a method for prediction of process defects by using the layout design data LDD according to another implementation. The description of the method of predicting the process defects with reference to FIG. 2 will be applied to the example of FIG. 3 in the similar or same manner. The redundant description will be omitted, and the description below will focus on the additions and modifications.

Referring to FIG. 3, the process defect prediction device according to one or more exemplary implementations may determine the presence of process defects associated with a plurality of tile regions based on a plurality of high-resolution height maps HRM to which the plurality of height maps HM is converted.

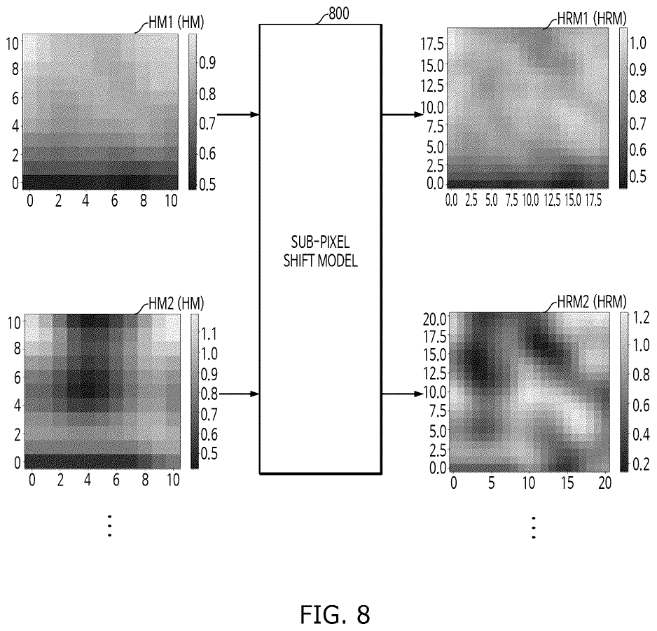

For example, the process defect prediction device may convert the plurality of height maps HM into a plurality of high-resolution height maps HRM. A sub-pixel shift technique may be used, or a pixel-by-pixel comparison-based resolution conversion model (e.g., a Mean Squared Error (MSE) calculation model, a Structural Similarity Index (SSIM)-based model, or a CNN (Convolutional Neural Network)-based super-resolution restoration model, etc.) may be used. However, the scope of the present disclosure is not limited thereto, and any resolution conversion model for generating the high-resolution height map HRM based on the height map HM may be used. Specific examples of the method for generating the high-resolution height maps HRM will be described in detail below with reference to FIGS. 8 to 10.

The process defect prediction device may determine the presence of process defects associated with the plurality of tile regions based on the plurality of high-resolution height maps HRM. For example, the process defect prediction device may perform a process simulation based on the surface shape of each of the plurality of tile regions TR corresponding to the plurality of high-resolution height maps HRM by using the process simulation model 300. The process defect prediction device may determine the defect region DR outside of a predetermined threshold range based on the changed surface shape of each of the plurality of tile regions TR according to the result of the process simulation.

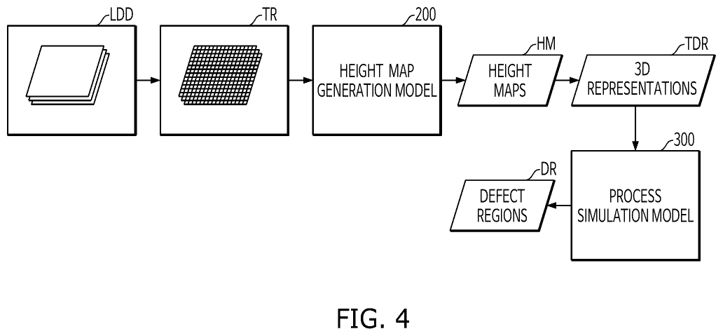

FIG. 4 is a block diagram provided to explain a method for prediction of process defects by using layout design data LDD according to yet another implementation. The description of the method of predicting the process defects with reference to FIG. 2 will be applied to the example of FIG. 4 in the similar or same manner. The redundant description will be omitted, and the description below will focus on the additions and modifications.

Referring to FIG. 4, a process defect prediction device may determine the presence of process defects associated with a plurality of tile regions based on a plurality of 3D representations TDR into which the plurality of height maps HM are converted.

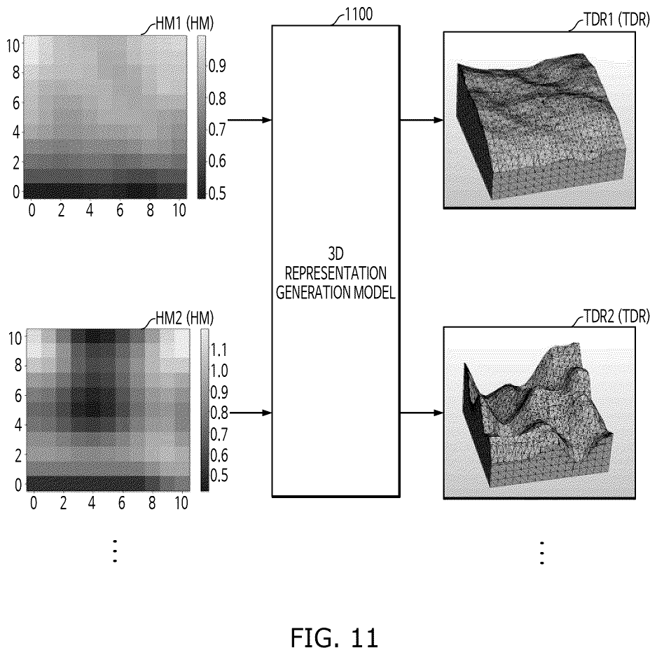

For example, the process defect prediction device may convert the plurality of height maps HM into the plurality of 3D representations TDR. A 3D reconstruction algorithm based on height maps may be used, but the present disclosure is not limited thereto, and an arbitrary 3D representation generation model for generating the 3D representation TDR may be used based on the height map HM. A specific example of the method for generating the 3D representations TDR may be described in detail with reference to FIG. 11.

The process defect prediction device may determine the presence of process defects associated with the plurality of tile regions based on the plurality of 3D representations TDR. For example, the process defect prediction device may perform a process simulation based on the surface shape of each of the plurality of tile regions TR corresponding to the plurality of 3D representations TDR, respectively. The process defect prediction device may determine the defect region DR outside of a predetermined threshold range based on the changed surface shape of each of the plurality of tile regions TR according to the result of the process simulation.

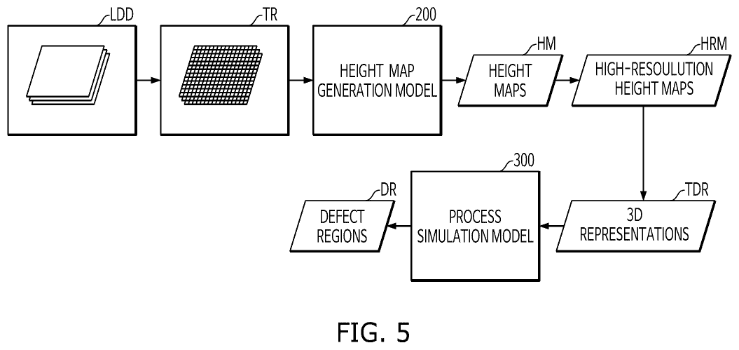

FIG. 5 is a block diagram provided to explain the method for prediction of process defects by using layout design data according to yet another implementation. The description of the method of predicting the process defects with reference to FIG. 2 to FIG. 4 will be applied to the example of FIG. 5 in the similar or the same manner. The redundant description will be omitted, and the description below will focus on the additions and modifications.

Referring to FIG. 5, the process defect prediction device may convert the plurality of height maps HM into the plurality of high-resolution height maps HRM, and generate the plurality of 3D representations TDR based on the plurality of converted high-resolution height maps HRM. The process defect prediction device may determine the presence of process defects associated with the plurality of tile regions based on the plurality of 3D representations TDR.

FIG. 6 and FIG. 7 are diagrams provided to explain a method for generating the height maps HM according to one or more exemplary implementations.

Referring to FIG. 6, the process defect prediction device may generate the plurality of height maps HM including height maps respectively corresponding to the plurality of tile regions TG. For example, the height map generation model 200 may generate a first height map HM1 by receiving a first tile region TR1, and a second height map HM2 by receiving a second tile region TR2.

The plurality of height maps HM may include relative height information between the neighboring layout patterns in each tile region TR, which is expressed in various forms. For example, the plurality of height maps HM may be image data in a form that visually represents height information. In this case, each pixel value may include height information for the corresponding coordinate. The plurality of height maps HM may be in the form of a two dimensional matrix (2D matrix) in which height values are numerically arranged, and each element of the matrix may include height information at a specific coordinate in the corresponding tile region.

According to one or more exemplary implementations, the height map generation model 200 may be a machine learning model configured to receive a plurality of tile regions TR and output a plurality of height maps HM including height maps (e.g., HM1, HM2, etc.) corresponding to the plurality of input tile regions TR, respectively. For example, the height map generation model 200 may be a neural network model such as a Convolutional Neural Network (CNN)-based model, a Generative Adversarial Network (GAN)-based model, or a neural operator model such as a Physics-Informed Neural Operator (PINO)-based model, but the scope of the present disclosure is not limited thereto. The process defect prediction device may generate height maps HM for the respective tile regions TR by inputting the tile regions TR to the height map generation model 200.

Referring to FIG. 7, the height map generation model 200 may be a machine learning model trained based on training design data 710 and measurement data 720 for the semiconductor device corresponding to the training design data 710. The measurement data 720 may include data of the height value of the semiconductor device manufactured by using the training design data 710.

During the training, the height map generation model 200 may receive the training design data 710 and the output data 730 including height map information. The weight of the height map generation model 200 may be updated based on a loss 740 calculated based on the output data 730 and the measurement data 720. The height map generation model 200 may be trained through the training process.

According to one or more exemplary implementations, the height map generation model 200 may be a neural operator model trained to receive the training design data 710 and the conditional variables (e.g., boundary conditions, initial conditions, etc.) for the training design data 710 and generate the output data 730 including the height map information. Based on the loss 740 calculated based on the output data 730 and the measurement data 720, the weight of the height map generation map model 200 may be updated. The height map generation model 200 may be trained through the training process.

The measurement data 720 may be generated and the height map generation model 200 may be trained by the process defect prediction device and/or the external device. The training process of the height map generation model 200 described above is only exemplary, but other training methods may be used, and the present disclosure is not limited thereto.

FIG. 8 to FIG. 10 are diagrams provided to explain a method for generating high-resolution height maps HRM according to one or more exemplary implementations.

Referring to FIG. 8, the process defect prediction device may generate a plurality of high-resolution height maps HRM including high-resolution height maps (e.g., HRM1, HRM2, etc.) corresponding to the plurality of height maps HM, respectively by using a sub-pixel shift model 800. For example, the sub-pixel shift model 800 may receive a first height map HM1 to generate a first high-resolution height map HRM1, and a second height map HM2 to generate a second high-resolution height map HRM2. The process defect prediction device may generate high-resolution height maps HRM by inputting low-resolution height maps HM to the sub-pixel shift model 800.

The sub-pixel shift model 800 may generate sub-pixel shifted height maps by horizontally, vertically, and/or diagonally shifting each of the low-resolution height maps HM by sub-pixel unit (e.g., 0.5 pixel, 0.25 pixel, etc.). The sub-pixel shift model 800 may combine the sub-pixel shifted height maps and apply an interpolation algorithm to generate a high-resolution height map HRM.

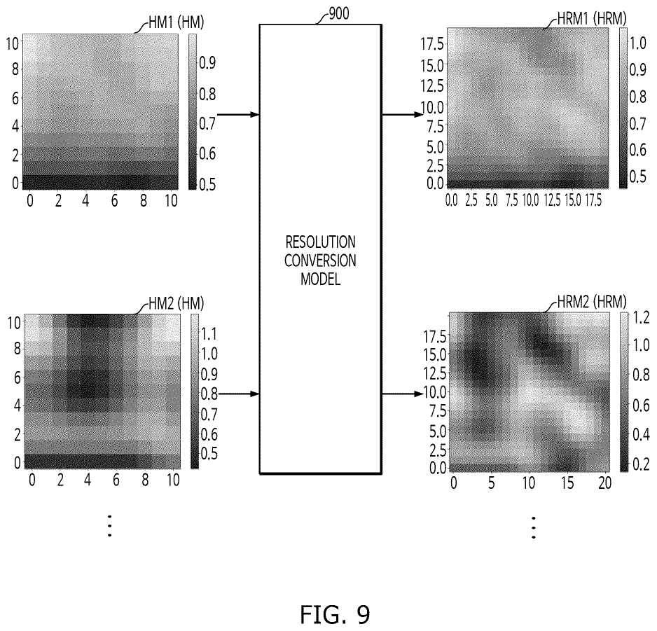

Referring to FIG. 9, the process defect prediction device may generate a plurality of high-resolution height maps HRM based on each of the plurality of height maps HM by using a resolution conversion model 900.

According to some implementations, the resolution conversion model 900 may be a machine learning model configured to receive low-resolution height maps HM as input and output the plurality of high-resolution height maps HRM respectively corresponding to the plurality of input low-resolution height maps HM. For example, the resolution conversion model 900 may be a neural network model such as a Convolutional Neural Network (CNN)-based model, a Generative Adversarial Network (GAN)-based model, or a neural operator model such as a Physics-Informed Neural Operator (PINO)-based model, but the scope of the present disclosure is not limited thereto. The process defect prediction device may generate high-resolution height maps HRM by inputting low-resolution height maps HM to the resolution conversion model 900.

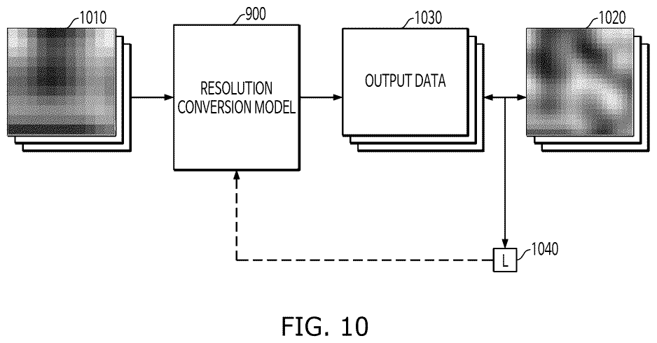

Referring to FIG. 10, the resolution conversion model 900 may be a machine learning model trained based on a training data set including a low-resolution image 1010 and a high-resolution image 1020, where the low-resolution image 1010 may be a training low-resolution image, and the high-resolution image 1020 may be a ground-truth high-resolution image.

According to one or more exemplary implementations, a portion included in the training data set may be generated through a data augmentation technique. For example, a training low-resolution image 1010 may be generated by applying various transformations (e.g., extracting a portion, deleting a portion, rotating, cropping, adding noise, etc.) to the ground-truth high-resolution image 1020 and performing a random down-sampling.

During the training process, the resolution conversion model 900 may receive the low-resolution image 1010 and the output data 1030 including a high-resolution image. Based on a loss 1040 calculated based on the output data 1030 and the ground-truth high-resolution image 1020, the weight of the resolution conversion model 900 may be updated. The resolution conversion model 900 may be trained through the training process.

According to one or more exemplary implementations, the resolution conversion model 900 may be a neural operator model trained to generate the output data 1030 including a high-resolution image by receiving the training low-resolution image 1010 and the conditional variables (e.g., resolution level, noise pattern, boundary condition, etc.) for the training low-resolution image 1010. Based on the loss 1040 calculated based on the output data 1030 and the ground-truth high-resolution image 1020, the weight of the resolution conversion model 900 may be updated. The resolution conversion model 900 may be trained through the training process.

The training data set may be generated and the resolution conversion model 900 may be trained by the process defect prediction device and/or the external device. The training process of the resolution conversion model 900 described above is only exemplary, but other training methods may be used, and the present disclosure is not limited thereto.

FIG. 11 is a diagram provided to explain a method for generating 3D representations TDR according to one or more exemplary implementations of the present disclosure. Referring to FIG. 11, a process defect prediction device may generate a plurality of 3D representations (TDR) including a 3D representation corresponding to each of a plurality of height maps HM by using a 3D representation generation model 1100. For example, the 3D representation generation model 1100 may receive a first height map HM1 as input to generate a first 3D representation TDR1, and a second height map HM2 to generate a second 3D representation TDR2.

According to one or more exemplary implementations, the 3D representation generation model 1100 may generate a 3D mesh by using coordinate information and height information on each point of the height map HM. The 3D representation generation model 1100 may form a mesh by connecting triangle elements based on coordinates and height values of each point to visualize the representation shape of each tile region in the design data.

According to one or more exemplary implementations, the 3D representation generation model 1100 may be a machine learning model configured to receive the plurality of height maps HM as input and output the plurality of 3D representations TDR including a 3D representation (e.g., TDR1, TDR2, etc.) corresponding to each of the plurality of input height maps HM. For example, the 3D representation generation model 1100 may be a neural network model such as a Convolutional Neural Network (CNN)-based model, a Generative Adversarial Network (GAN)-based model, or a neural operator model such as a Physics-Informed Neural Operator (PINO)-based model, but the scope of the present disclosure is not limited thereto. The process defect prediction device may generate 3D representations TDR for respective tile regions TR by inputting the height maps HM into the 3D representation generation model 1100.

FIG. 11 illustrates an example in which the 3D representation generation model 1100 generates the 3D representations TDR based on the height maps (e.g., low-resolution height maps HM), but the input data of the 3D representation generation model 1100 is not limited thereto. For example, the process defect prediction device may generate the 3D representations TDR for respective tile regions TR by inputting a high-resolution height map (e.g., HRM of FIG. 3) into the 3D representation generation model 1100.

FIG. 12 is a diagram provided to explain a method for determining a defect region DR according to one or more exemplary implementations.

Referring to FIG. 12, the process defect prediction device may perform a process simulation based on a surface shape 1210 of respective tile regions corresponding to the plurality of height maps by using a process simulation model 1200.

Referring to FIG. 12, the process simulation model 1200 may generate a surface shape 1220 of each of the tile regions that is changed as a result of the process simulation performed based on the surface shape 1210 of each of the tile regions. For example, the process simulation model 1200 may generate a first changed surface shape 1222 by receiving a first surface shape 1212, and a second changed surface shape 1224 by receiving a second surface shape 1214. The surface shape 1210 may be one of the height map (e.g., HM of FIG. 2), the high-resolution height map (e.g., HRM of FIG. 3), or the 3D representation (e.g., TDR of FIG. 4 and FIG. 5), or include information based on one of the above.

According to one or more exemplary implementations, the process defect prediction device may further include design data (LDD of FIG. 1) associated with the surface shape 1210 of respective tile regions corresponding to the plurality of height maps and the process defect prediction target device, and/or data measuring the height value of the target device manufactured using the design data in the process simulation model 1200. The measuring data input into the process simulation model 1200 may include measurement meta information including detailed information such as measurement conditions, measurement environments, etc. along with coordinate information for each point on the surface of the subject device. However, the present disclosure is not limited thereto. Additionally or alternatively, the input data of the process simulation model 1200 may include the design data for the process simulation and the conditions or setting values required for each process step.

The process simulation model 1200 may include a computer-based design tool (e.g., a Technology Computer-Aided Design Tool (TCAD tool)) used to perform physical characteristics and process simulation of semiconductors and electronic devices. For example, the process simulation model 1200 may include a model that simulates a semiconductor manufacturing process (e.g., etching, ion implantation, oxidation, deposition, etc.), and performs modeling and predicting on physical phenomena that occur at each process step. Additionally or alternatively, the process simulation model 1200 may include a model that simulates electrical and physical characteristics of semiconductor devices to predict the operations thereof.

According to one or more exemplary implementations, the process simulation model 1200 may be a machine learning model trained based on a training data set including process variable data and process result data. The process variable data and the process result data may include the design data for the process simulation and the conditions and setting values required for each process step. Additionally or alternatively, the training data set may further include training design data and training measurement data for the target device manufactured by using the training design data. For example, the process simulation model 1200 may be a neural network model such as a Convolutional Neural Network (CNN)-based model, a Generative Adversarial Network (GAN)-based model, or a neural operator model such as a Physics-Informed Neural Operator (PINO)-based model, but the scope of the present disclosure is not limited thereto. The process defect prediction device may input one of a height map (e.g., HM of FIG. 2), a high-resolution height map (e.g., HRM of FIG. 3), or a 3D representation (e.g., TDR of FIGS. 4 and 5) into the process simulation model 1200, thereby outputting the performance result of the process simulation for each of the tile regions TR. The result of the process simulation may be used to determine whether each tile region corresponds to a defect region.

According to one or more exemplary implementations, defects may be predicted through the subsequent process simulation flexibly adjusted based on the layout patterns, and analyzed from various perspectives by selecting various application processes, thereby identifying process defects in advance and effectively responding thereto.

According to one or more exemplary implementations, the design data may be divided into a plurality of tile regions, and an individual simulation may be performed with great speed based on the height information on each tile region. Therefore, the defect prediction for full-chip design data may be performed with great speed.

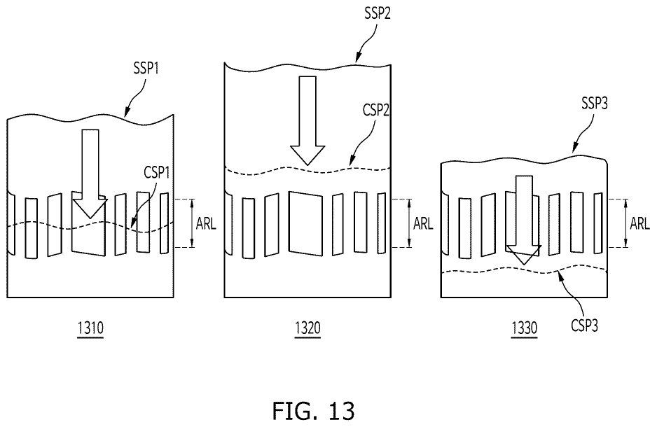

FIG. 13 illustrates an example of a method of determining a defect region through the result of performing a process simulation for each tile region. Referring to FIG. 13, the process defect prediction device may determine a defect region outside of a predetermined threshold range ARL based on changed surface shapes CSP1, CSP2 and CSP3 of respective tile regions according to the result of the process simulation.

According to one or more exemplary implementations, the process simulation may include a polishing process simulation. For example, the polishing process simulation may be a simulation for a chemical mechanical polishing (CMP) process. In this case, the process defect prediction device may determine whether the changed surface shape of each tile region is overpolished or underpolished as the result of performing the polishing process simulation. The scope of the process simulation is not limited to the polishing process simulation, but various process simulations may be performed.

A first example 1310 may be an example in which an initial surface shape SSP1 of a first tile region is changed to a changed surface shape CSP1 of the first tile region after the polishing process simulation of the first tile region. In this case, the changed surface shape CSP1 of the first tile region may be within the predetermined threshold range ARL, and the process defect prediction device may determine the first tile region as a normal region (e.g., normal-polished state).

A second example 1320 may be an example in which an initial surface shape SSP2 of a second tile region is changed to a changed surface shape CSP2 of the second tile region after the polishing process simulation of the second tile region. In this case, the vertical level of the changed surface shape CSP2 of the second tile region may be higher than the upper vertical level of a predetermined threshold range ARL, and the process defect prediction device may determine the second tile region as a defect region (e.g., a defect due to under-polished state).

A third example 1330 may be an example in which an initial surface shape SSP3 of a third tile region is changed to a changed surface shape CSP3 of the third tile region after the polishing process simulation of the third tile region. In this case, the vertical level of the changed surface shape CSP3 of the third tile region may be lower than the lower vertical level of the predetermined threshold range ARL, and the process defect prediction device may determine the third tile region as a defect region (e.g., defect due to over-polished state).

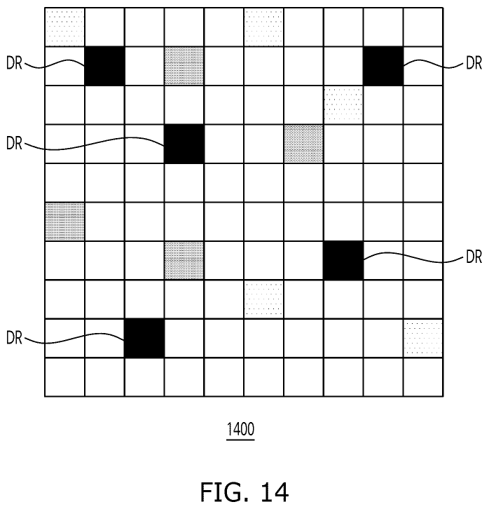

FIG. 14 illustrates an example of a process defect color map 1400 including a defect region DR determined according to one or more exemplary implementations. Referring to FIG. 14, a process defect prediction device according to one or more exemplary implementations may generate the process defect color map 1400 for a semiconductor chip by using a relative defect index for the process defects associated with each tile region. For example, the process defect prediction device may calculate the defect index based on the changed surface shape of each region, evaluate the presence of defects in each tile region based on the defect index, and generate the process defect color map 1400.

The process defect prediction device may determine a defect index associated with each tile region based on the changed surface shape of each tile region. As a specific example, the process defect prediction device may calculate a defect index by using statistical figures such as a Z-score based on the height value of the changed surface shape of each tile region as a result of performing the process simulation, but the present disclosure is not limited thereto.

The process defect prediction device may determine the presence of process defects associated with each tile region based on the defect index associated with each tile region. As a specific example, the process defect prediction device may determine the tile region determined to include process defects among a plurality of tile regions in the design data as the defect region DR.

The process defect prediction device may generate the process defect color map 1400 by applying visual elements corresponding to the defect index associated with each tile region. The region including defects may be intuitively identified by visually representing the defect state of each tile region in the semiconductor chip through the process defect color map 1400.

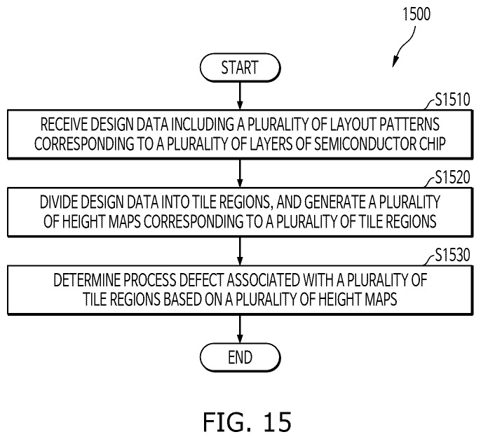

FIG. 15 is a flowchart illustrating an example of a process defect prediction method 1500 according to the one or more exemplary implementations of the present disclosure. Referring to FIG. 15, the process defect prediction method 1500 according to one or more exemplary implementations may be performed by a processor (e.g., at least one processor of a process defect prediction device).

The processor may receive design data including a plurality of layout patterns corresponding to a plurality of layers of a semiconductor chip in step S1510. According to one or more exemplary implementations, the design data may include layout patterns up to a predetermined process stage of the entire manufacturing process for the semiconductor chip.

The processor may divide the design data into tile regions, and generate a plurality of height maps corresponding to a plurality of tile regions in step S1520. As a specific example, the processor may divide the design data into a plurality of tile regions by using a window of a predetermined size. The processor may predict the height value of each point in each tile region by using the height map generation model to generate the plurality of height maps corresponding to the plurality of tile regions, respectively. According to one or more exemplary implementations, the height map generation model may be a machine learning model trained based on the training design data and the measurement data for the semiconductor device corresponding to the training design data.

The processor may determine the presence of process defects associated with the plurality of tile regions based on the plurality of height maps in step S1530. The processor may generate a plurality of high-resolution height maps based on each of the plurality of height maps. As a specific example, the processor may generate a plurality of high-resolution height maps by using a sub-pixel shift technique based on the plurality of height maps. According to another example, the processor may generate a plurality of high-resolution height maps based on each of the plurality of height maps by using a high-resolution conversion model. According to one or more exemplary implementations, the resolution conversion model may be a machine learning model trained based on a training data set including a low-resolution image and a high-resolution image. The processor may determine the presence of process defects associated with the plurality of tile regions based on the plurality of high-resolution height maps. The processor may generate the plurality of high-resolution height maps based on each of the plurality of height maps, and a plurality of 3D representations corresponding to the plurality of high-resolution height maps, respectively. The processor may determine the presence of process defects associated with the plurality of tile regions based on the plurality of generated 3D representations.

According to one or more exemplary implementations, the processor may perform a process simulation based on the surface shapes of the respective tile regions corresponding to the plurality of height maps by using a process simulation model. According to one or more exemplary implementations, the process simulation model may be a machine learning model trained based on the training data set including the process variable data and the process result data. The processor may determine a defect region outside of a predetermined threshold range based on the changed surface shape of each tile region according to the result of the process simulation. According to one or more exemplary implementations, the process simulation may include a polishing process simulation. The processor may determine a defect region by determining whether the changed surface shape of each tile region is over-polished or under-polished as a result of performing the polishing process simulation. Additional research or analysis may be performed to resolve the cause of the defect on the tile regions determined to include the process defects among the plurality of tile regions through the process defect prediction device and/or the external device.

According to one or more exemplary implementations, the processor may determine a defect index associated with each tile region based on the changed surface shape of each tile region. The processor may determine the presence of process defects related to the respective tile regions based on the defect index associated with the respective tile regions.

The processor may generate a process defect color map for the semiconductor chip by using a relative defect index for the process defects related to each tile region.

The processor may identify the suspected layout pattern predicted to cause process defects among the plurality of layout patterns based on the tile region determined to have the process defects based on the plurality of tile regions.

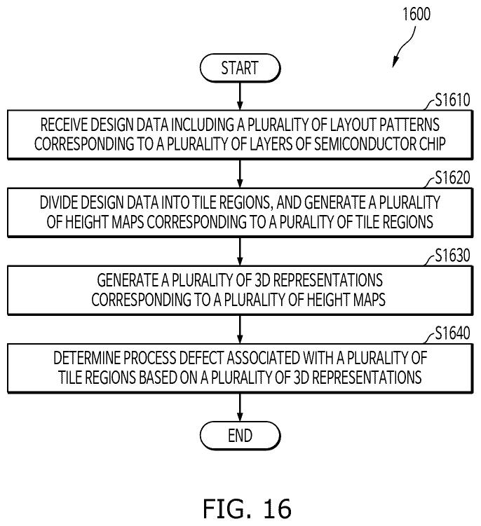

FIG. 16 is a flowchart illustrating an example of a process defect prediction method 1600 according to one or more exemplary implementations of the present disclosure. Referring to FIG. 16, the process defect prediction method 1600 according to one or more exemplary implementations may be performed by a processor (e.g., at least one processor of the process defect prediction device). The redundant description with reference to FIG. 15 will be omitted or briefly detailed.

The processor may receive design data including a plurality of layout patterns corresponding to a plurality of layers of a semiconductor chip in step S1610. The processor may divide the design data into tile regions, and generate a plurality of height maps corresponding to the plurality of tile regions in step S1620. The processor may generate the plurality of 3D representations respectively corresponding to the plurality of height maps in step S1630. Based on the plurality of 3D representations, the processor may determine the presence of process defects associated with the plurality of tile regions in step S1640. As a specific example, the processor may perform a subsequent process simulation based on the surface shapes of the respective tile regions corresponding to the plurality of 3D representations by using a process simulation model. The processor may determine a defect region outside of a predetermined threshold range based on the changed surface shape of each tile region according to the result of the process simulation.

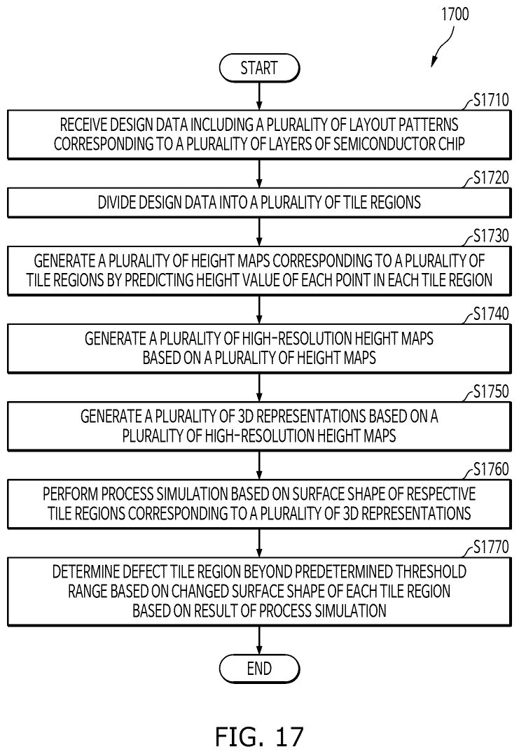

FIG. 17 is a flowchart illustrating an example of a process defect prediction method 1700 according to one or more exemplary implementations of the present disclosure. Referring to FIG. 17, the process defect prediction method 1700 may be performed by a processor (e.g., at least one processor of the process defect prediction device). The redundant description with reference to FIG. 15 and FIG. 16 will be omitted or briefly detailed below.

The processor may receive the design data including a plurality of layout patterns corresponding to a plurality of layers of a semiconductor device in step S1710. The processor may divide the design data into a plurality of tile regions in step S1720. The processor may generate the plurality of height maps respectively corresponding to the plurality of tile regions by predicting the height value of each point in each tile region in step S1730. The processor may generate a plurality of high-resolution height maps based on each of the plurality of height maps in step S1740. The processor may generate the plurality of 3D representations based on each of the plurality of high-resolution height maps in step S1750. The processor may perform a process simulation based on the surface shapes of the respective tile regions corresponding to the plurality of 3D representations in step S1760. The processor may determine a defect region outside of a predetermined threshold range based on the changed surface shape of each tile region according to the result of the process simulation in step S1770.

The flowchart and explanation described with reference to FIGS. 15 to 17 are exemplary only, but may be differently implemented in other one or more exemplary implementations. For example, the order of steps may be changed, part of steps may be repeatedly performed, part of steps may be omitted or added.

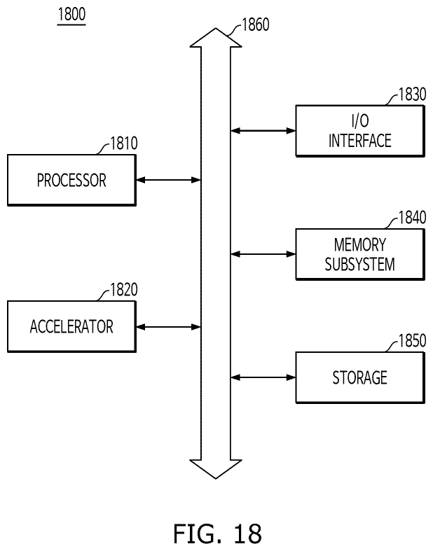

FIG. 18 is a block diagram illustrating an example of a process defect prediction system 1800 according to one or more exemplary implementations of the present disclosure.

Referring to FIG. 18, a process defect prediction system 1800 may include a processor 1810, an accelerator 1820, an input and output interface 1830, a memory sub-system 1840, a storage 1850 and a bus 1860. Each of the processor 1810 and the memory sub-system 1840 of FIG. 18 may correspond to the processor 110 and the memory 120 of the FIG. 1, and the redundant description will be omitted.

The processor 1810, the accelerator 1820, the input and output interface 1830, the memory sub-system 1840 and the storage 1850 may communicate with one another through the bus 1860. According to one or more exemplary implementations, the process defect prediction system 1800 may be system-on chip (SoC) in which elements are embodied in a single chip, and the storage 1850 may be placed outside the system-on-chip. According to one or more exemplary implementations, at least one of the elements illustrated in FIG. 18 may be omitted in the process defect prediction system 1800.

The processor 1810 may control the operations described with reference to the drawings in the process defect prediction system 1800 at the top level, and control other elements of the process defect prediction system 1800.

According to one or more exemplary implementations, the processor 1810 may include two (2) or more processing cores. As described above with the drawings, the processor 1810 may process the steps required for the operations of the process defect prediction system 1800 to determine a specific region in the design data predicted to cause defects in the manufacturing process of semiconductor devices.

The accelerator 1820 may be designed to perform a designated function at high speed. For example, the accelerator 1820 may provide the data generated by processing the data received from the memory sub-system 1840 to the memory sub-system 1840.

The input and output interface 1830 may receive an input from the outside of the process defect prediction system 1800, and provide an interface for providing an output to the outside of the process defect prediction system 1800. For example, the process defect prediction system 1800 may receive design data and a reference threshold range (a predetermined threshold range, etc.) used for determining the presence of process defects, etc. from the outside through the input and output interface 1830. However, the present disclosure is not limited thereto. For example, at least part of the above data may be provided in the process defect prediction system 1800.

The memory subsystem 1840 may be accessed by other components connected to the bus 1860. According to one or more exemplary implementations, the memory subsystem 1840 may include volatile memory, such as DRAM, SRAM, or non-volatile memory, such as flash memory, resistive random access memory (RRAM). According to one or more exemplary implementations, the memory subsystem 1840 may provide an interface for the storage 1850. The storage 1850 may be a storage medium that contains data even when power is blocked. For example, the storage 1850 may include a semiconductor memory device such as non-volatile memory, or any storage medium, such as a magnetic card/disk or an optical card/disk. According to one or more exemplary implementations, the design data may be stored in the memory subsystem 1840 or the storage 1850. According to one or more exemplary implementations, the various data described above that are necessary to determine a specific region in the design data where a defect is predicted may be stored in the memory subsystem 1840 or the storage 1850.

The bus 1860 may operate based on one of various bus protocols. The various bus protocols may include at least one of Advanced Microcontroller Bus Architecture (AMBA) protocol, Universal Serial Bus (USB) protocol, Multimedia Card (MMC) protocol, Peripheral Component Interconnection (PCI) protocol, PCI-Express (PCI-E) protocol, Advanced Technology Attachment (ATA) protocol, Serial-ATA protocol, Parallel-ATA protocol, Small Computer Small Interface (SCSI) protocol, Enhanced Small Disk Interface (ESDI) protocol, Integrated Drive Electronics (IDE) protocol, Mobile Industry Processor Interface (MIPI) protocol, Universal Flash Storage (UFS) protocol, etc.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The present disclosure has been described with reference to exemplary implementations and drawings, and the implementations have been described using specific terms throughout the specification. It is only for the purpose of explaining the technical spirits of the present disclosure, but is not used to limit the scope of the present disclosure described in the claims. It will be apparent to those skilled in the art that various modifications and changes may be made within the scope of the appended claims and their equivalents. Therefore, the technical protection scope of the present disclosure should be determined by the technical spirit of the appended claims.

What is claimed is:

1. A method for prediction of process defects performed by at least one processor, the method comprising:
receiving design data comprising a plurality of layout patterns corresponding to a plurality of layers of a semiconductor chip;
dividing, by the at least one processor, the design data into tile regions;
generating, based on the design data, a plurality of height maps corresponding to a plurality of tile regions; and
determining, by the at least one processor, a presence of process defects associated with the plurality of tile regions based on the plurality of height maps.

2. The method as claimed in claim 1, wherein generating the plurality of height maps comprises:
dividing the design data into the plurality of tile regions by using a window of a predetermined size.

3. The method as claimed in claim 1, wherein generating the plurality of height maps comprises:
predicting a height value of each point in each tile region of the plurality of tile regions based on a height map generation model.

4. The method as claimed in claim 3, wherein the height map generation model is a machine learning model trained based on training design data and measurement data for a semiconductor device corresponding to the training design data.

5. The method as claimed in claim 1, wherein determining the presence of the process defects comprises:
generating a plurality of high-resolution height maps based on each height map of the plurality of height maps; and
determining the presence of process defects associated with the plurality of tile regions based on the plurality of high-resolution height maps.

6. The method as claimed in claim 5, wherein generating the plurality of high-resolution height maps comprises generating, based on the plurality of height maps, the plurality of high-resolution height maps using a sub-pixel shift method.

7. The method as claimed in claim 5, wherein generating the plurality of high-resolution height maps comprises:
generating the plurality of high-resolution height maps based on each height map of the plurality of height maps by using a resolution conversion model,
wherein the resolution conversion model is a machine learning model trained based on a training data set comprising a low-resolution image and a high-resolution image.

8. The method as claimed in claim 1, wherein determining the presence of the process defects comprises:
generating a plurality of high-resolution height maps based on each height map of the plurality of height maps;
generating a plurality of 3D representations respectively corresponding to the plurality of high-resolution height maps; and
determining the presence of the process defects associated with the plurality of tile regions based on the plurality of generated 3D representations.

9. The method as claimed in claim 1, wherein determining the presence of the process defects comprises:
performing a process simulation based on surface shapes of respective tile regions corresponding to the plurality of height maps by using a process simulation model; and
determining a defect region outside of a predetermined threshold range based on changed surface shapes of the respective tile regions according to a result of the process simulation.

10. The method as claimed in claim 9, wherein the process simulation comprises a polishing process simulation, and
wherein determining the defect region comprises:
identifying whether changed surface shapes of the respective tile regions are overpolished or underpolished as a result of performing the polishing process simulation.

11. The method as claimed in claim 9, wherein determining the defect region comprises:
determining a defect index associated with the respective tile regions based on changed surface shapes of the respective tile regions; and
determining a presence of process defects associated with the respective tile regions based on the defect index associated with the respective tile regions.

12. The method as claimed in claim 9, wherein the process simulation model is a machine learning model trained based on a training data set comprising process variable data and process result data.

13. The method as claimed in claim 1, comprising:
generating a process defect color map for the semiconductor chip based on a relative defect index for process defects associated with respective tile regions.

14. The method as claimed in claim 1, comprising:
identifying, based on a tile region classified as including process defects among the plurality of tile regions, a suspected layout pattern predicted to cause the process defects among the plurality of layout patterns.

15. The method as claimed in claim 1, wherein the design data includes layout patterns up to a predetermined process stage of an entire manufacturing process for the semiconductor chip.

16. A method for prediction of process defects, the method comprising:
receiving design data comprising a plurality of layout patterns corresponding to a plurality of layers of a semiconductor chip;
dividing, by at least one processor, the design data into tile regions;
generating, by the at least one processor, a plurality of height maps corresponding to a plurality of tile regions;
generating, based on the design data, a plurality of 3D representations respectively corresponding to the plurality of height maps; and
determining, by the at least one processor, a presence of process defects associated with the plurality of tile regions based on the plurality of 3D representations.

17. The method as claimed in claim 16, wherein determining the presence of the process defects comprises:
performing a process simulation based on surface shapes of respective tile regions corresponding to the plurality of 3D representations by using a process simulation model; and
determining a defect region outside of a predetermined threshold range based on changed surface shapes of the respective tile regions according to a result of the process simulation.

18. The method as claimed in claim 16, comprising:
generating a process defect color map for the semiconductor chip based on a relative defect index for process defects associated with tile regions.

19. The method as claimed in claim 16, comprising:
identifying, based on a tile region characterized as including process defects, a suspected layout pattern predicted to cause the process defects among the plurality of layout patterns.

20. A method for prediction of process defects, the method comprising:
receiving design data comprising a plurality of layout patterns corresponding to a plurality of layers of a semiconductor chip;
dividing, by at least one processor, the design data into a plurality of tile regions;
generating a plurality of height maps respectively corresponding to the plurality of tile regions by predicting a height value of each point in each tile region;
generating a plurality of high-resolution height maps based on each of the plurality of height maps;
generating a plurality of 3D representations based on the plurality of high-resolution height maps;
performing a process simulation based on surface shapes of respective tile regions corresponding to the plurality 3D representations; and
determining a defect region outside of a predetermined threshold range based on changed surface shapes of the respective tile regions according to a result of the process simulation.
